(19) United States
(12) Patent Application Publication
(10) Pub. No.: US 2012/0283082 A1
(43) Pub. Date: Nov. 8, 2012

(54) ROLLER FOR SEALED HEAD AND PROCESS FOR MANUFACTURING

(76) Inventors: Hervé Schulthess, Zillisheim (FR); Pierre Henry, Rixheim (FR); Philippe Massotte, Gueberschwihr (FR); Roland Stohler, Munchwilen (CH)

(21) Appl. No.: 13/447,315

(22) Filed: Apr. 16, 2012

(30) Foreign Application Priority Data
May 4, 2011 (FR) 1153796

(51) Int. Cl. B32B 37/02; F16C 13/00

(52) U.S. Cl. 492/56; 156/185

(57) ABSTRACT

The object of the present invention is a manufacturing process for a roller composed of a metal core covered by an elastomer coating and having an axis of symmetry, this process involving a first winding of a first non-vulcanized elastomer sheet onto the core, a vulcanization.

This process is characterized in that it involves at least one stage consisting of doing a complementary winding, following the first winding and preceding vulcanization, winding at least one second sheet of non-vulcanized elastomer, the first sheet and the one or more second sheets being such that the hardnesses obtained after vulcanization are different.

The object of the invention is also the monolithic elastomer roller with a heterogeneous hardness obtained by this process.

Application to the making of rollers for sealed heads of textile thread processing machines.

### CROSS REFERENCE TO RELATED APPLICATION

This application claims the benefit of French Patent Application No. 1153796 filed on May 4, 2011, the contents of which are incorporated herein by reference.

### DESCRIPTION

The field of the present invention is that of the rollers used in the sealed heads for textile thread processing machines. More particularly, the object of the invention is a particular roller and the way it is made.

The sealed heads for textile thread processing machines generally have two rollers with an elastomer coating, arranged one above the other in such a way that their axis of rotation is horizontal and perpendicular to the movement of the thread, and which are pressed against one another to assure the required sealing. Sealing joints are also applied to each roller, essentially at the level of the generator opposite the closest one of the other roller. Vertical sealing plates are applied to the axial ends of the rollers. The contact between, on the one hand, these fixed vertical sealing plates, and on the other, the movable rollers rotating around their axis, creates great friction forces on the elastomer coating. It is thus usual to provide the elastomer coating, at its axial ends, with inserts that are sufficiently rigid to withstand this friction. Generally, when such a roller needs to have some areas that are more rigid than others in its elastomer coating, this involves adding an insert.

Adding an insert still presents the following problems: the manufacturing process for the roller is longer, there is not always sufficient mechanical adhesion of this insert to the elastomer coating or to the metallic core, sometimes requiring the use of screws, and removing the inserts is delicate when the elastomer coating is changed.

The purpose of the present invention is to alleviate at least some or preferably all these problems by proposing, on the one hand, a roller with a monolithic elastomer coating with hardness variations, and on the other, a process for making this type of roller from elastomer sheets.

To this end, the object of the invention is a process of manufacturing rollers for sealed heads of textile thread processing machines, said roller being composed of a metal core covered with an elastomer coating and having an axis of symmetry, a procedure involving stages consisting, on the one hand, of making a first winding of a first sheet of non-vulcanized elastomer onto the core, then, on the other, of vulcanizing the roller. This procedure is characterized in that it also involves at least one stage that consists of making a complementary winding, following the first winding and prior to the vulcanization, winding at least one second sheet of non-vulcanized elastomer in order to complete the elastomer coating produced after the first winding or after a prior complementary winding, the first sheet and, at least, the one second sheet being made of materials such that the hardnesses obtained after vulcanization for, on the one hand, the first sheet, and on the other, at least, the one second sheet, are different.

The object of the invention is also a roller for the sealed heads of textile thread processing machines, said roller being composed of a metal core covered with an elastomer coating and having an axis of symmetry. This roller is characterized in that the elastomer coating, after being vulcanized, forms a monolithic elastomer element of heterogeneous hardness.

The invention will be easier to understand from the following description, which refers to preferred embodiments, provided as non-limiting examples, and explained with reference to the attached schematic drawings, in which:

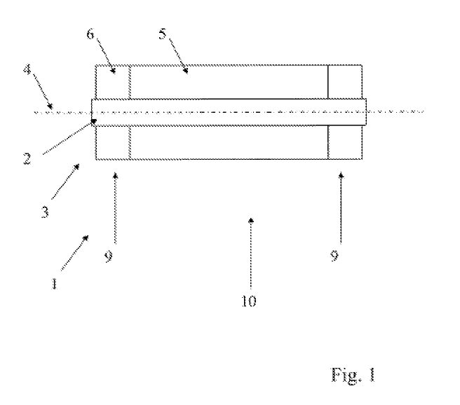

FIGS. 1 to 3 represent rollers according to the invention, in three different embodiments, and

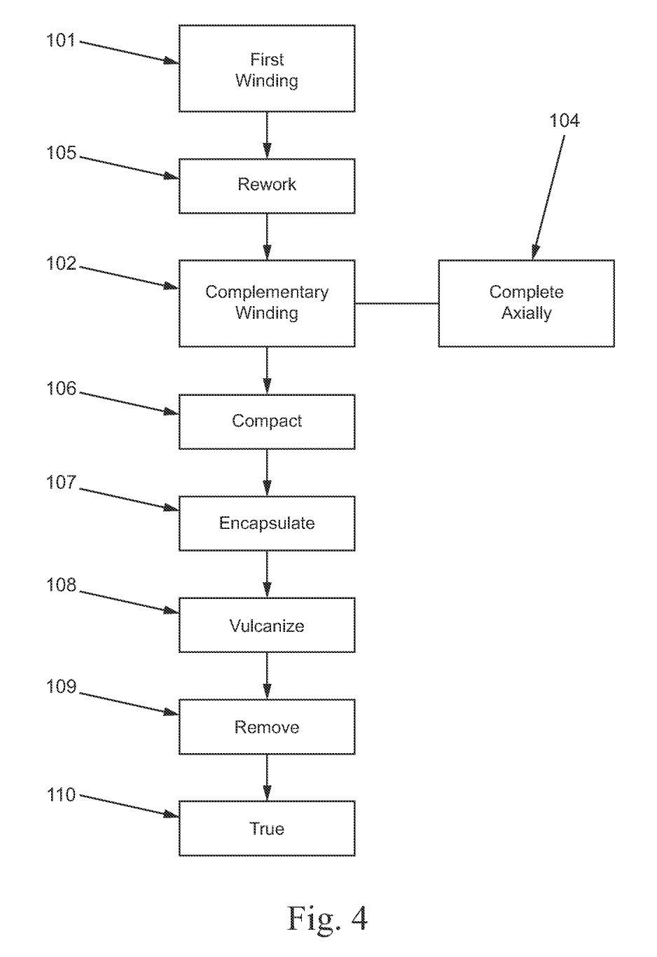

FIGS. 4 to 6 represent manufacturing procedures according to the invention.

Thus from the very outset the object of the invention is a procedure for manufacturing a roller 1 for the sealed heads of textile thread processing machines, said roller 1 being composed of a metal core 2 covered with an elastomer coating 3 and having an axis of symmetry 4, a process involving stages consisting, on the one hand, of making a first winding 101 of a first sheet 5 of non-vulcanized elastomer onto the core 2, then, on the other hand, of vulcanizing 108 the roller 1. Of course, the vulcanization 108 affects only the elastomer coating 3 and vulcanizes its constituent sheets, that is to say, the first sheet 5, and, as described farther on, at least one second sheet 6.

According to the invention, this process also includes at least one stage consisting of making a complementary winding 102, following the first winding 101 and preceding the vulcanization 108, winding at least one second sheet 6 of non-vulcanized elastomer to complete the elastomer coating 3 obtained after the first winding 101 or after a prior complementary winding 102, the first sheet 5 and the one or more second sheets 6 being made with materials such that the hardnesses obtained after vulcanization 108 for, on the one hand, the first sheet 5, and on the other, the one or more second sheets 6, are different.

The hardness represents the mechanical elasticity and is not necessarily limited to a surface characteristic. The first sheet 5 and the one or more second sheets 6 are, for example, made from nitrile, and provided with different loads that give them a different hardness after the vulcanization 108.

The elastomer coating 3 represents the elastomeric matter around the core 2, at the different stages of manufacturing the roller 1, in other words, after the first winding 101, after a complementary winding 102, after the vulcanization 108, or still in use. The elastomer coating 3 can thus consist solely of the first sheet 5 wound around the core 2 and still not vulcanized, or of the combination of the first sheet 5 and at least one second sheet 6, before or after the vulcanization stage 108. The stages consisting of doing the first winding 101 and doing the complementary winding 102 thus allow each one to form the elastomer coating 3. The process can involve several complementary winding stages 102, each one completing the elastomer coating 3 by winding at least one second sheet 6.

According to one possible characteristic illustrated in FIG. 4, the, at least, one complementary winding stage 102 consists of completing axially 104 the elastomer coating 3 in the direction of the axis of symmetry 4, in other words, winding, toward each end of the elastomer coating 3 along the axis of symmetry 4, at least one second sheet 6. Thus, the procedure may possibly include a succession of complementary winding stages 102, each of them making it possible to complete axially 104 the elastomer coating 3 with a second sheet 6 having a different hardness after vulcanization 108.

In particular embodiments, the process involves a single complementary winding stage 102 consisting of completing axially 104 the elastomer coating 3 and, thus, of winding toward each end of the first sheet 5 along the axis of symmetry 4, a second sheet 6, the hardnesses obtained after vulcanization of these two second sheets 6, then being equal with one another and greater than the hardness obtained after vulcanization of the first sheet 5, such that harder axial ends for the elastomer coating 3 are obtained after vulcanization. Their hardness must allow the roller 1 to withstand the pressure in the direction of the axis of symmetry 4, without damaging the axial ends of the elastomer coating 3. It is thus possible to obtain a roller 1, illustrated in FIG. 1, the hardness of whose elastomer coating 3, after being vulcanized, varies axially along the axis of symmetry 4, that is to say, parallel to the latter, and, preferably, has an initial hardness value for its two axial end portions 9 along the axis of symmetry 4, and a second hardness value, considerably lower, between these two portions.

In other embodiments, the process involves several stages of complementary winding 102, each consisting of completing axially 104 the elastomer coating 3. Thus, the first stage of complementary winding 102 completes axially the elastomer coating 3 that the first sheet 5 forms, the second stage of complementary winding 102 completes axially the second sheets 6 previously wound onto the ends of the first sheet 5, the third stage of winding 102 completes axially the second sheets 6 previously winded onto the ends of other second sheets 6, and so on. It is thus possible to make a roller 1 with different zones distributed axially, each of roughly homogenous hardness but different from one zone to the other.

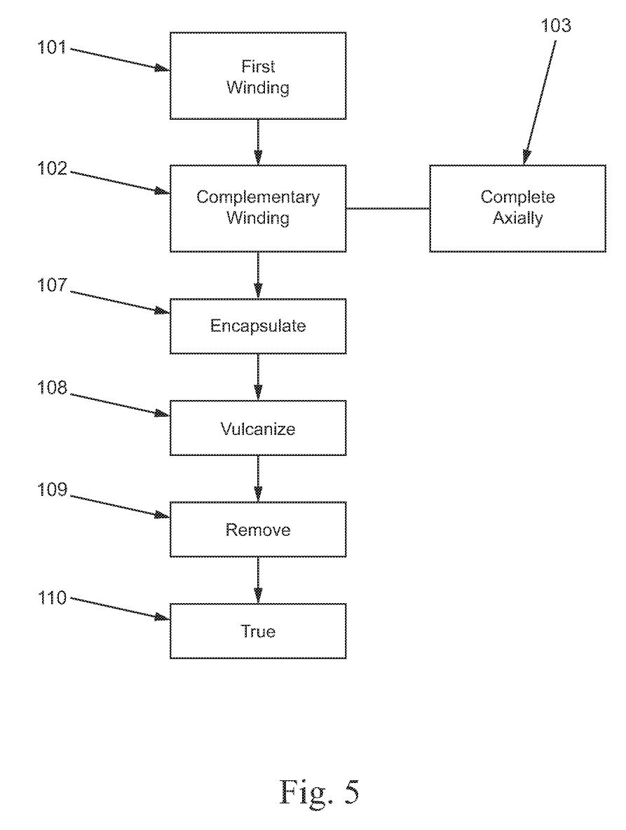

According to one complementary or alternative characteristic illustrated in FIG. 5 the, at least, one stage of complementary winding 102 consists of completing radially 103 the elastomer coating 3 in a direction perpendicular to the axis of symmetry 4, in other words, of winding a second sheet 6 around the elastomer coating 3 in order to produce, after vulcanization 108, a radial variation in the hardness of the elastomer coating 3, in other words, a variation perpendicular to the axis of symmetry 4. Several complementary winding stages 102 can follow one another, the elastomer coating 3 then being gradually completed radially by several second sheets 6. The hardnesses of the first sheet 5 and the one or more second sheets 6 used for completing radially 103 the elastomer coating 3 are different after vulcanization.

It is conceivable, before the first winding 101, to join mechanically, by gluing, stitching, or other means, the first sheet 5 to the, at least, one second one 6, and to thus do the first winding 101 and the second winding 102 continuously, since in simple embodiments, the one or more second sheets 6 are intended to be wound around or on either side of the first sheet 5. One thus winds a succession of sheets connected to one another in series.

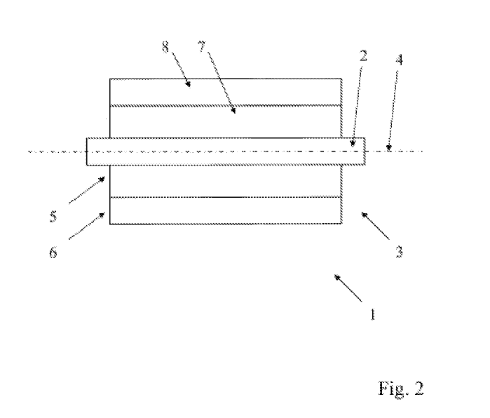

According to an additional possible characteristic, the process involves a single stage of complementary winding 102 consisting of completing radially 103 the elastomer coating 3 and thus winding around the first sheet 5 a second sheet 6 whose hardness after vulcanization is different from, more particularly greater than, the hardness obtained after vulcanization of the first sheet 5. It is thus possible to obtain a roller 1, illustrated in FIG. 2, of which the hardness of the elastomer coating 3, after being vulcanized 108, varies radially around the axis of symmetry 4, in other words, perpendicular to the latter, and preferably has, on the one hand, an initial hardness value for a core area 7, immediately surrounding the core 2, and on the other, a second hardness value, more particularly greater, for a peripheral zone 8 surrounding the core area 7 and ending at the surface of the elastomer coating 3. The core area 7 is thus essentially formed by the first sheet 5, the peripheral zone 8 being formed essentially by the second sheet 6, preferably leading to a greater hardness after vulcanization 108.

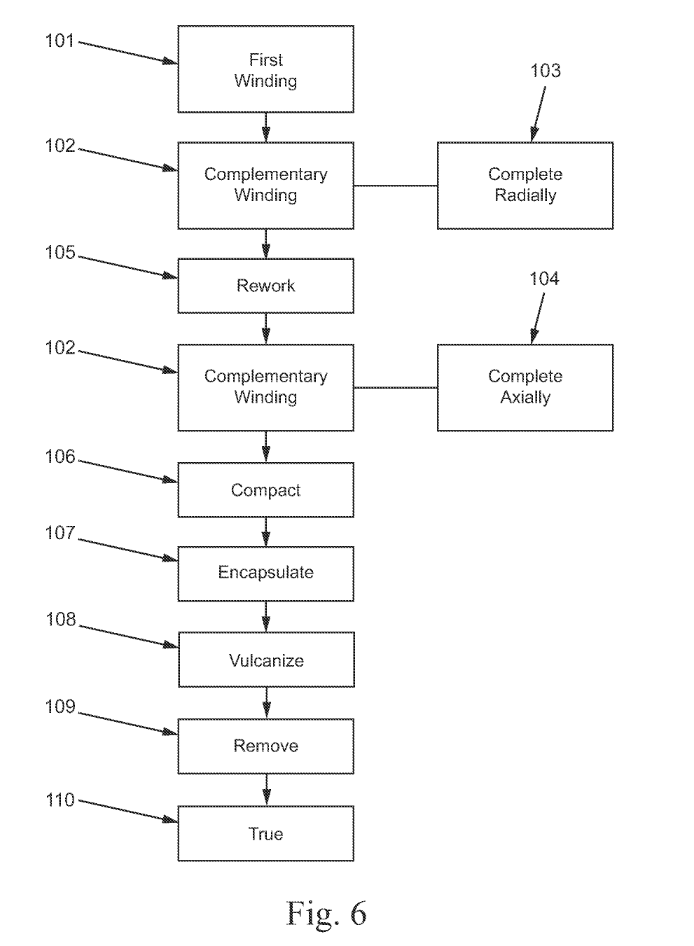

In a particular embodiment illustrated in FIG. 6, the procedure involves a first stage of complementary winding 102 consisting of completing radially 103 the elastomer coating 3 in a direction perpendicular to the axis of symmetry 4, in other words, of winding a second sheet 6 around the elastomer coating 3, then a second stage of complementary winding 102 consisting of completing axially 104 the elastomer coating 3 in the direction of the axis of symmetry 4, in other words, winding, toward each end of the elastomer coating 3 along the axis of symmetry 4, at least one second sheet 6.

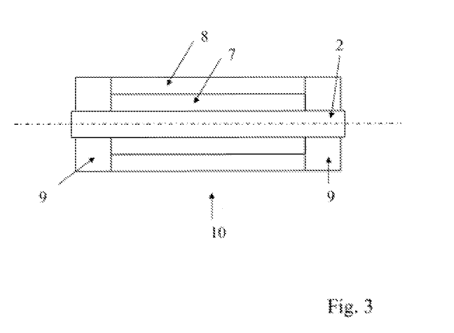

It is thus possible to obtain a roller 1 illustrated in FIG. 3 whose elastomer coating 3, after being vulcanized 108, has one initial hardness value for its axial end portions 9 along the axis of symmetry 4, a second hardness value, preferably lower than the mentioned initial value, in a core area 7 located between these two axial end portions 9 and extending radially from core 2, and a third hardness value, more particularly between the two other hardness values, in a peripheral zone 8 surrounding core area 7, ending at the surface of the elastomer coating 3 and delimited by the axial end portions 9. The core area 7 is formed essentially by the first sheet 5, the peripheral zone 8 being formed essentially by the second sheet 6 wound around the first sheet 5 at the time of the first complementary winding stage 102 consisting of completing radially 103, and the axial end portions 9 being formed essentially by the second sheets 6 wound on either side of the first sheet 5 at the time of the second complementary winding stage 102 consisting of completing axially 104 the elastomer coating 3.

In certain embodiments, the procedure involves a succession of complementary winding stages 102, making it possible, on the one hand, to complete part of them axially 104, and for another part of them, to complete radially 103 the elastomer coating 3. The first winding 101 of the first sheet 5 may thus, in a general way, be followed by any series of actions consisting of completing radially 103 the elastomer coating 3 or completing it axially 104. The hardnesses of the second sheets 6, wound around or toward an axial end of the elastomer coating 3, are preferably different after vulcanization 108. More complex configurations for different hardness zones can thus be obtained by combining, after the first winding 101, complementary winding stages 102 to complete axially 104 or to complete radially 103 the elastomer coating 3.

According to a possible additional characteristic, making it possible to guarantee good adhesion after vulcanization 108 between, on the one hand, the second sheets 6 used to complete axially 104 the elastomer coating 3, and on the other, the mentioned elastomer coating 3, more particularly the first sheet 5 directly, the procedure involves at lease one rework stage 105 by removing material from the axial ends of the elastomer coating 3, this rework stage 105 being done, on the one hand, after the first winding 101, and, possibly, after one or more stages consisting of completing radially 103, and on the other, before one or more stages consisting of completing axially 104, this rework 105 being done more particularly with a hot wire or a hot metal blade. This rework phase 105 can consist of removing the material from only the first sheet 5, only from a second sheet 6 wound beyond the axial ends of the first sheet 5, from a second sheet 6 wound around the first sheet 5, as well as on said first sheet 5, or another one.

According to a possible additional characteristic also making it possible to promote adhesion between the first sheet 5 and the second sheets 6 used to complete the elastomer coating 3, the process also involves a stage of axial compacting 106, consisting of squeezing the axial ends of the elastomer coating 3 toward one another and done after one or more stages consisting of completing axially 104.

Finally, preferably, the process also involves stages consisting of encapsulating 107 the roller 1 in a shell surrounding the elastomer coating 3, done, on the one hand, after the stage or the last stage consisting of doing a complementary winding 102 and before vulcanizing 108 said roller 1, of removing 109 the roller 1 from the shell, after the vulcanization 108, then of truing 110 the roller 1, in particular the elastomer coating 3.

FIGS. 4 to 6 illustrate the preferred embodiments that are detailed below.

Thus, in one preferred embodiment illustrated in FIG. 4, the procedure first involves a preparation stage of the core 2, which consists of coating the latter with adhesive material, the purpose of which is to mechanically stabilize the elastomer coating 3 on the core 2. A first sheet 5 of non-vulcanized elastomeric material is then wound around core 2, to do a first winding 101, with as many turns as necessary so that the obtained roller 1 has the desired outer diameter. The ends of core 2 go beyond the first sheet 5. The ends, along the axis of symmetry 4, of the first wound sheet 5, are then reworked 105, by removing material in order to assure their evenness perpendicular to the axis of symmetry 4. After the first winding 101 of the first sheet 5 around the core 2, it is indeed possible that the ends, along the axis of symmetry 4 of the first wound sheet 5, have an irregular surface due, for example, to a slight variation in the width of the first sheet 5, and/or to a slight offset along the axis of symmetry 4, of the first sheet 5 at the time of winding. The purpose of the reworking 105 of the ends of the first wound sheet 5 is, thus, to lead to flat, perpendicular surfaces at the axis of symmetry 4. This stage is preferably done with a hot metal wire.

After the second operation 105 to the axial ends of the first wound sheet 5, a complementary winding 102 is done to complete axially 104 and consists of winding, toward each surface of the axial end of the first sheet 5, a second sheet 6 of non-vulcanized elastomer. This second sheet 6 is made of a material such that after vulcanization 108, its hardness is greater than that of the first sheet 5. The part of the core 2 onto which the second sheet 6 is wound has, of course, also been prepared with an adhesive material, for example, glue. The second sheets 6 have a width, in other words, a dimension in the direction of the axis of symmetry 4, much smaller than the first sheet 5, and thus appear more in the form of small strips.

The elastomer coating 3 obtained thus consists of a winding of a first sheet 5 around the core 2 and forming a central portion 10, and, toward each of the ends of the central portion 10, a winding of a second sheet 6, each forming a portion of axial end 9, as shown in FIG. 1.

The elastomer coating 3 then undergoes axial compacting 106, in the direction of the axis of symmetry 4, so as to guarantee good contact between the first sheet 5 and the two second sheets 6 for the vulcanization stage 108. The elastomer coating 3 is then encapsulated 107 in a shell, then the assembly is placed into a furnace for the vulcanization stage 108. After vulcanization 108, the elastomer coating 3 of roller 1 then has a different hardness, between, on the one hand, the portions of the axial end 9 along the axis of symmetry 4 formed by the two second sheets 6, and on the other, the central portion 10 which is located between these portions of axial end 9 and which is formed by the first sheet 5. The portions of the axial end 9 have a greater hardness than the central portion 10, which allows roller 1, once it is installed in the sealed head, to be squeezed axially along the axis of symmetry 4, at the elastomer coating 3, without damaging the latter at its axial end portions 9, by this pressure.

The portions of the axial end 9 of greater hardness are thus joined by vulcanization to the central portion 10 of lesser hardness, thus ending up with a monolithic elastomer coating 3, assuring a good mechanical bond between these three portions and thus good mechanical resistance for the elastomer coating 3.

In the preferred embodiment illustrated in FIG. 5, the process makes it possible to make a roller 1 whose elastomer coating 3 is monolithic and presents a radially variable hardness, in other words, perpendicular to the axis of symmetry 4. Thus, after the stage consisting of doing a first winding 101 with a first sheet 5, the following stage involves a complementary winding 102, consisting of completing radially 103 the winding formed by the first sheet 5. Thus, a second sheet 6 is wound around the first sheet 5. The elastomer coating 3 is thus formed, perpendicular to the axis of symmetry 4, in a succession of layers of the first sheet 5, then a succession of layers of the second sheet 6. These sheets are preferably of the same width. The rework phase 105, making it possible to obtain an even surface perpendicular to the axis of symmetry 4 at the axial ends of the winding formed by the first sheet 5, is also preferably done, after the complementary winding stage 102, independently of the final winding of another sheet of elastomer toward these ends. The first sheet 5 and the second sheet 6 are made from materials such that the hardnesses after vulcanization are different, more particularly a greater hardness for the second sheet 6, intended to form the peripheral zone 8, than for the first sheet 5, intended to form the core area 7.

The final roller 1 thus has a monolithic elastomer coating 3, since the second sheet 6 is joined to the first sheet 5 by vulcanization just as, on the one hand, the different layers of the second sheet 6 are joined to one another, and on the other, the different layers of the first sheet 5 are joined to one another. The hardness of the elastomer coating 3 has a radially variable hardness, given the different constituent materials of the first sheet 5 and the second sheet 6. The hardness may be greater at the surface of the elastomer coating 3 than near the core 2, or vice-versa.

In the preferred embodiment illustrated in FIG. 6, the process involves two complementary winding stages 102. After the first winding stage 101, at which time a first sheet 5 is wound onto a core 2, a first stage of complementary winding 102 takes place, radially completing 103 the first sheet 5, and thus consisting of winding, onto the first sheet 5, a second sheet 6, the rigidity of which after vulcanization may be greater than that of the first sheet 5. After this first complementary winding 102, the axial ends of the elastomer coating 3 thus formed, on the one hand, from the first sheet 5, and on the other, from the second sheet 6 wound on top, are reworked 105 by removing material, in such a way as to assure an even shape that is also perpendicular to the axis of symmetry 4.

The procedure then involves a second stage consisting of doing a complementary winding 102, completing axially 104 the elastomer coating 3 formed by the successive windings of the first sheet 5 and the second sheet 6, and consisting of winding, toward each end of the elastomer coating 3 along the axis of symmetry 4, a second sheet 6 of non-vulcanized elastomer material whose hardness after vulcanization is different from that of the first sheet 5 and possibly also from other second sheets 6.

The elastomer coating 3 thus has a central portion 10 that consists, on the one hand, of the core area 7 formed by the first wound sheet 5, and on the other, in the peripheral zone 8 formed by the second sheet 6 wound around the first sheet 5. It also has two portions of axial end 9 on both sides of the central portion 10, formed by the second sheets 6 wound at the time of the second complementary winding 102. It is thus possible to obtain an elastomer coating 3 made up, on the one hand, of a central portion 10 consisting of a core area 7 and a peripheral zone 8 with different hardnesses, and on the other, two portions of axial end 9 on both sides of the central portion 10 and of the same diameter, intended to be squeezed toward one another once the roller 1 is in use and thus preferably of greater hardness.

The object of the invention is also a roller for a sealed head of a textile thread processing machine, the roller 1 of which being composed of a metallic core 2 covered with an elastomer coating 3 and having an axis of symmetry 4. According to the invention, the elastomer coating 3 forms, after being vulcanized 108, a monolithic elastomer element of heterogeneous hardness. Particular versions of such a roller 1, with the procedure described, have already been presented above. Forming the elastomer coating 3 by vulcanization 108 based on winding sheets of non-vulcanized elastomer material, that is, a first sheet 5 and at least one second sheet 6 wound around or at the end of the elastomer coating 3, these sheets being made from materials such that they have different hardnesses after vulcanization 108, makes it possible to obtain, after said vulcanization stage 108, an elastomer coating 3, on the one hand, monolithic more particularly due to the proximity of the different sheets at the time of the vulcanization 108, and on the other, of heterogeneous hardness more particularly due to the different constituent materials of these sheets.

Of course, the invention is not limited to the embodiments described and represented in the attached drawings. Modifications are still possible, more particularly from the point of view of the makeup of the various elements or by substituting equivalent techniques, without necessarily leaving the sphere of protection for the invention.

1. A procedure for manufacturing a roller for the sealed head of a textile thread processing machine, said roller being composed of a metallic core covered with an elastomer coating and having an axis of symmetry, a procedure involving stages consisting, on the one hand, of doing a first winding of a first sheet of non-vulcanized elastomer onto the core, then, on the other, of vulcanizing the roller, characterized in that
it also involves at least one stage consisting of doing a complementary winding, following the first winding and before the vulcanization, winding at least one second sheet of non-vulcanized elastomer in such a way as to complete the elastomer coating obtained after the first winding or after a prior complementary winding, the first sheet and the one or more second sheets being made from materials such that the hardnesses obtained after vulcanization for, on the one hand, the first sheet and on the other, the one or more second sheets, are different, and in that
the one or more stages of complementary winding consist of completing axially the elastomer coating in the direction of the axis of symmetry, in other words, winding, toward each end of the elastomer coating along the axis of symmetry, at least one second sheet.

2. The procedure for manufacturing a roller according to claim 1, characterized in that it involves a single stage of complementary winding consisting of completing axially the elastomer coating and thus of winding, toward each end of the first sheet along the axis of symmetry, a second sheet, the hardnesses obtained after vulcanization of these two second sheets thus being equal to one another and greater than the hardness obtained after vulcanization of the first sheet.

3. The procedure for manufacturing a roller according to claim 1, characterized in that it also involves at least one stage of complementary winding which consists of completing radially the elastomer coating in a direction perpendicular to the axis of symmetry, in other words, of winding a second sheet around the elastomer coating.

4. The procedure according to claim 3, characterized in that it involves a single stage of complementary winding consisting of completing radially the elastomer coating and thus of winding, around the first sheet, a second sheet whose hardness after vulcanization is different from, more particularly greater than, the hardness obtained after vulcanization of the first sheet.

5. The procedure for manufacturing a roller according to claim 1, characterized in that it involves a first stage of complementary winding consisting of completing radially the elastomer coating in a direction perpendicular to the axis of symmetry, in other words, of winding a second sheet around the elastomer coating, then a second stage of complementary winding consisting of completing axially the elastomer coating in the direction of the axis of symmetry, in other words, winding, toward each end of the elastomer coating along the axis of symmetry, at least one second sheet.

6. The procedure for manufacturing a roller according to claim 3, characterized in that it involves at least one rework stage by removal of material from the axial ends of the elastomer coating, this rework stage being done, on the one hand, after the first winding, and possibly, after one or more stages consisting of completing radially, and on the other, before one or more stages consisting of completing axially, this rework being done more particularly with a hot wire or a hot metal blade.

7. The procedure for manufacturing a roller according to claim 3, characterized in that it also involves a stage of axial compacting, consisting of squeezing the axial ends of the elastomer coating toward one another and done after one or more stages consisting of completing axially.

8. The procedure for manufacturing a roller according to claim 1, characterized in that it also involves stages consisting of encapsulating the roller in a shell surrounding the elastomer coating, done, on the one hand, after the stage or the last stage consisting of doing a complementary winding and before vulcanizing said roller, of removing the roller from the shell, after the vulcanization, then truing the roller, in particular the elastomer coating.

9. A roller for sealed head of textile thread processing machine, said roller being composed of a metal core covered with an elastomer coating and having an axis of symmetry, characterized in that the elastomer coating forms, after being vulcanized, a monolithic elastomer element of heterogeneous hardness, and in that
the hardness of the elastomer coating, after being vulcanized, varies axially along the axis of symmetry, in other words, parallel to the latter.

10. The roller according to claim 9, characterized in that the hardness of the elastomer coating, after being vulcanized, varies radially around the axis of symmetry, in other words, perpendicularly to the latter, and preferably, has, on the one hand, an initial hardness value for a core area, surrounding the core directly, and on the other, a second hardness value, more particularly greater, for a peripheral zone, surrounding the core area and ending up at the surface of the elastomer coating.

11. The roller according to claim 9, characterized in that the hardness of the elastomer coating, after being vulcanized, has an initial hardness value for its two axial end portions along the axis of symmetry, and a second hardness value, more particularly lower, between these two portions.

12. The roller, according to claim 9, characterized in that the hardness of the elastomer coating, after being vulcanized, has an initial hardness value for its axial end portions along the axis of symmetry, a second hardness value, preferably lower than said initial value, in a core area located between these two axial end portions and extending radially from the core, and a third hardness value, more particularly between the two other hardness values, in a peripheral zone surrounding the core area, ending at the surface of the elastomer coating and delimited by the axial end portions.
